(19) United States
(12) Patent Application Publication
(10) Pub. No.: US 2026/0098486 A1
(43) Pub. Date: Apr. 9, 2026

(54) ANNULAR DEVICE, AIRCRAFT ENGINE WITH AN ANNULAR DEVICE, AND A METHOD FOR MANUFACTURING AN ANNULAR DEVICE

(71) Applicant: ROLLS-ROYCE DEUTSCHLAND LTD & CO KG, Blankenfelde-Mahlow (DE)

(72) Inventors: Reyya Nitin RAO, Berlin (DE); Christoph KLAUS, Teltow (DE)

(21) Appl. No.: 19/348,987

(22) Filed: Oct. 3, 2025

(30) Foreign Application Priority Data
Oct. 8, 2024 (DE) 10 2024 129 035.8

(51) Int. Cl. F01D 25/24

(52) U.S. Cl. CPC F01D 25/243; F05D 2220/323; F05D 2240/14; F05D 2300/6034; F05D 2300/612

(57) ABSTRACT

The disclosure relates to an annular component for an aircraft gas turbine, having a front flange structure in the direction of flight, a rear flange structure in the axial direction and an annulus structure arranged between the flange structures in the axial direction, wherein the annulus structure has a variable cross-sectional form and/or a variable material arrangement in the circumferential direction and/or perpendicularly to the circumferential direction and at least one of the flange structures has at least two annular portions in the circumferential direction, which are each arranged at a different angle relative to the annulus structure. The disclosure furthermore relates to an aircraft gas turbine having an annular component and a method for producing the annular component.

This application claims priority to German Patent Application 102024129035.8 filed Oct. 8, 2024, the entirety of which is incorporated by reference herein.

### DESCRIPTION

The invention relates to an annular component having the features of claim 1, an aircraft gas turbine having an annular component having the features of claim 12 and a method for producing an annular component having the features of claim 13.

Components in aircraft gas turbines are subject to significant requirements in terms of strength, weight and fire resistance, which can only be met through careful selection and adaptation of the design features. In many cases, these components are produced from, or comprise, composite materials, as known from US 2016 / 0263856 A1, for example. Examples of such components include fan housings in aircraft gas turbines or parts for the bypass duct. Typically, such annular components have flanges on lateral surfaces in order to connect the annular components to other components and/or to enable the annular components to be centered. A flange may refer to an edge which protrudes from the component and which serves, in particular, for connection to another component, the components abutting against one another in a flush or substantially flush manner.

The object, therefore, is to provide annular components which have a low weight along with a high strength.

The object is achieved by an annular component having the features of claim 1.

The annular component for an aircraft gas turbine has a front flange structure in the direction of flight. Furthermore, the annular component has a rear flange structure in the axial direction and an annulus structure between the flange structures. In a cross section which is perpendicular to the circumferential direction, the annular component therefore essentially has a U-shaped cross section. The annulus structure here has a variable cross-sectional form and/or a variable material arrangement in the circumferential direction and/or perpendicularly to the circumferential direction. This means that the annulus structure may be anisotropic in terms of the materials and/or the cross sections. This anisotropy may be produced in the axial direction (perpendicularly to the circumferential direction) and/or in the circumferential direction, so that a wide variety of design options is available.

Furthermore, at least one of the flange structures of the annular component has at least two annular portions in the circumferential direction, the annular portions each being arranged at a different angle relative to the annulus structure. Whilst a flange which is known per se is bent-usually through 90° - from an annular structure, the flange structure of the subject matter according to claim 1 has a more complex form. As a result of the different angles, a smoother transition from the plane of the annulus structure to the distal, radially outer portion of the flange structure is produced.

Several optimization options are thus created. In this regard, structural optimization and associated weight optimization are enabled. High-performance materials and lightweight construction materials (e.g. carbon fibers) may be used to meet the structural requirements. This may be achieved, for example, via the variable cross sections (staggered layup) or via integrated reinforcing parts. In some embodiments, it is also possible to arrange fibers at a 90° angle in the flange regions.

In one embodiment, a first angle between the annulus structure and the first portion of the flange structure, in particular the front flange structure, is in the range between 10 and 60° and/or a second angle of 90° is present between the annulus structure and the second portion of the flange structure. The first angle therefore represents a chamfer starting from the annulus structure. This portion having the first angle then merges into the portion having the second right angle, so that the axially outer flange surface of the flange structure then forms a vertical flange surface.

An angle between the annulus structure and the rear flange structure may also be 90°, for example. The rear flange structure may therefore extend, in particular, perpendicularly to the annulus structure.

The angles are each measured between the center axes / center planes of the annulus structure and the at least one flange structure in the direction of the plane of the annulus structure.

Furthermore, the at least one flange structure and/or the annulus structure may be connected to a reinforcing structure and/or a fire protection layer or they may be formed in one piece.

An example of anisotropy in the component is when at least a region of the cross-sectional form of the annulus structure has a cross-sectional widening in the circumferential direction around the center line.

In one embodiment, at least one connection means, reinforcing structure and/or reinforcing means is arranged in an integrated manner on the outside of the annulus structure and/or in the annulus structure. The connection means serves, for example, for connection to another component. The reinforcing means may be, for example, a specific stiffening in a region in which a load is applied to the component or in which particular aerodynamic conditions (e.g. due to gases) must be observed.

The inside of the annulus structure may also be at least partly aerodynamically contoured. This contour of the inside of the annulus defines the outer boundary of the region of the gas path of the gas turbine engine through which air flows. In addition, it is possible to use a filler material which is as light as possible (e.g. a plastic foam) and which ensures a uniform transition/connection of the gas path from the inside of the annulus to the adjacent component, typically a fan case.

In a further embodiment, the annulus structure and/or at least one of the flange structures is connected to an insert, in particular a foam core or an annular insert. The insert may serve, for example, to fill an edge or cavity which is produced in an assembly comprising neighboring components. This may create an aerodynamically favorable gas path.

An efficient and mechanically stable embodiment is produced if the component can be at least partly produced using a deposition method or winding method, in particular with a staggered layup. The type of deposition and/or the type of winding and/or the respective material may be different at least in two regions of the flange structures and/or the annulus structure.

The object is achieved by an aircraft gas turbine having the features of claim 12 and by a method having the features of claim 13.

During the production process, a base form of an annular component may, in particular, be produced first.

An insert, for example a foam core or an annular insert, may then be produced separately, during which at least one layer of composite material is arranged in a molding tool, the insert - in particular a foam core or an annular insert - being arranged on this at least one layer. The insert may then be sheathed by the at least one layer so that the foam core has, on the outside, an area impregnated with resin, for example, which is suitable for connection to an area of the annular component. This insert is then connected to the base form of the annular component, in particular in an autoclave.

The invention will be explained in conjunction with the exemplary embodiments illustrated in the figures, in which

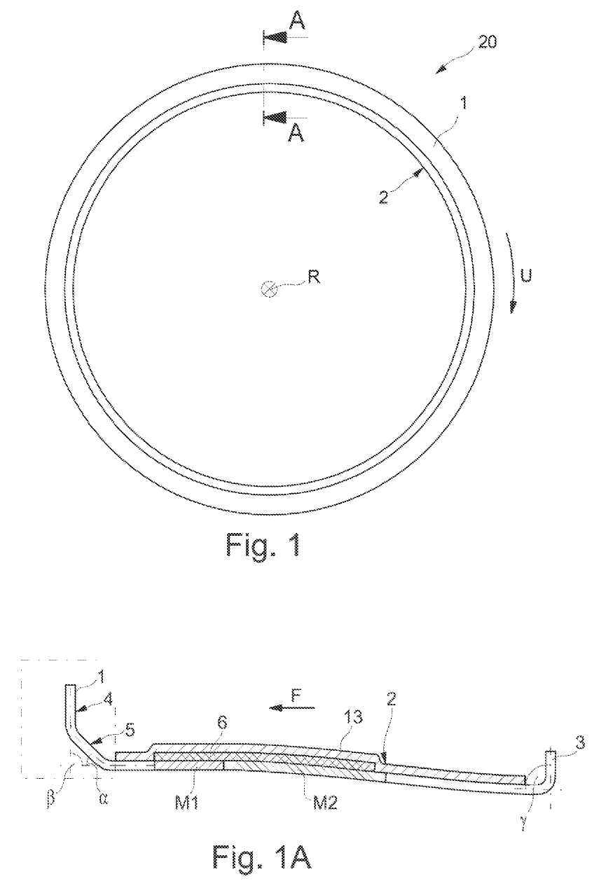

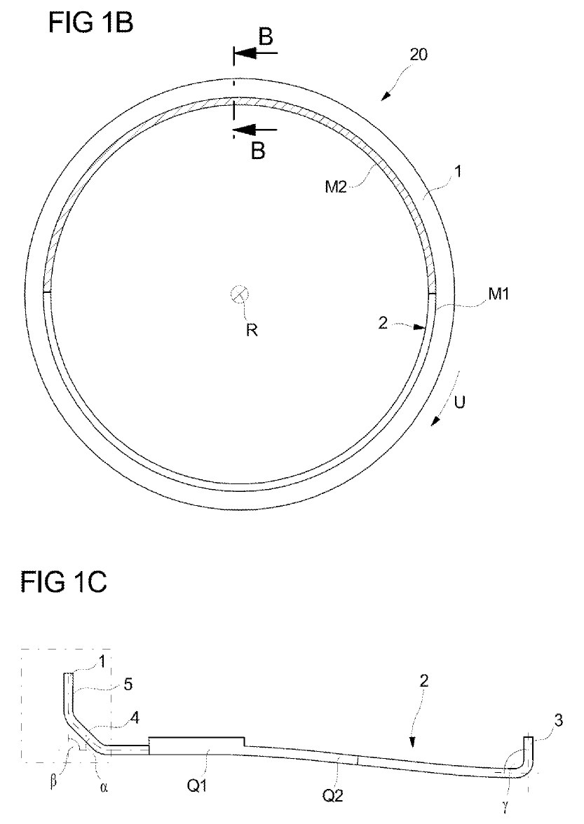

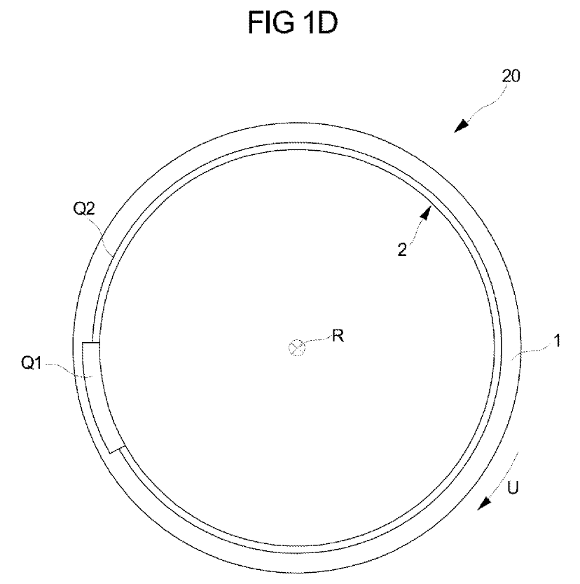

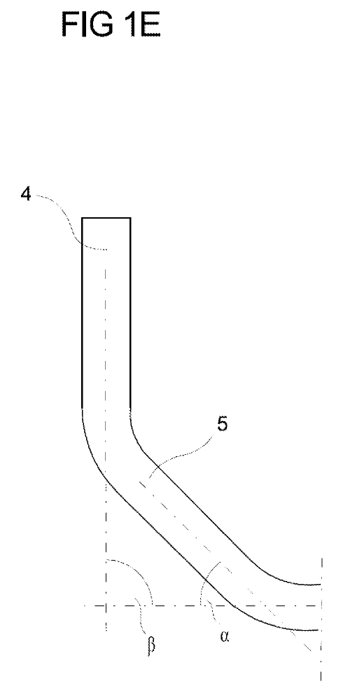

FIG. 1 shows a view of a first embodiment of an annular component in the axial direction;

FIG. 1A shows a sectional view of the first embodiment along the plane A-A in FIG. 1 with variable material arrangements in the axial direction;

FIG. 1B shows a sectional view of the first embodiment perpendicularly to an axis of rotation with variable material arrangements in the circumferential direction;

FIG. 1C shows a sectional view of the first embodiment along the plane A-A in FIG. 1 with variable cross-sectional forms in the axial direction;

FIG. 1D shows a sectional view of the first embodiment perpendicularly to the axis of rotation with variable cross-sectional forms in the circumferential direction;

FIG. 1E shows a detailed view of the region denoted by a dot-and-dash line in FIG. 1A;

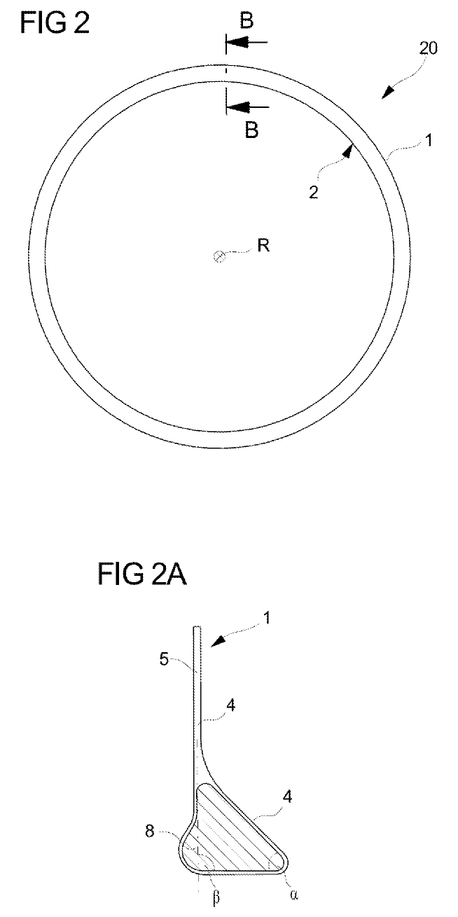

FIG. 2 shows a view of a second embodiment of the annular component in the axial direction;

FIG. 2A shows a sectional view of the second embodiment along the line B-B in FIG. 2;

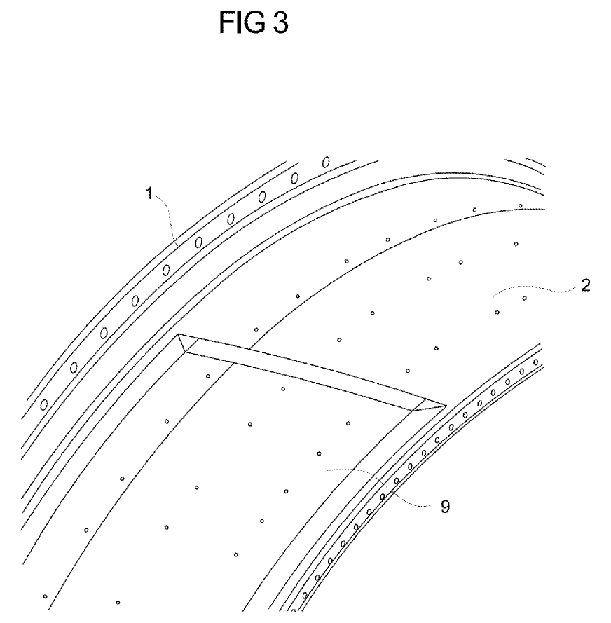

FIG. 3 shows a perspective detailed view of a third embodiment with a region having additional material in an annulus structure;

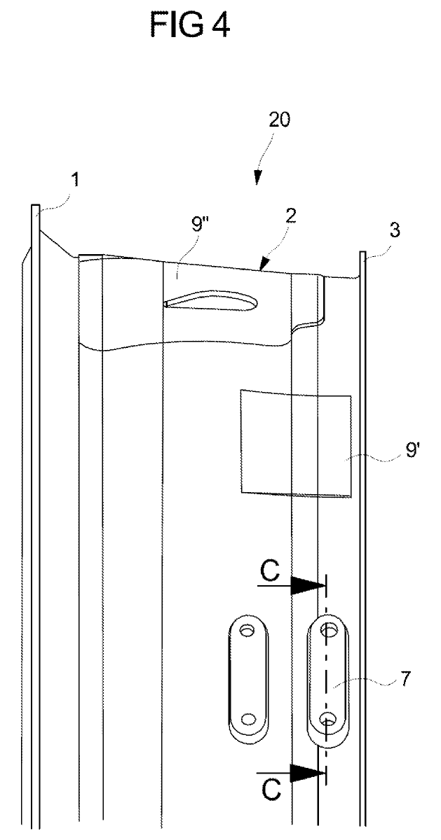

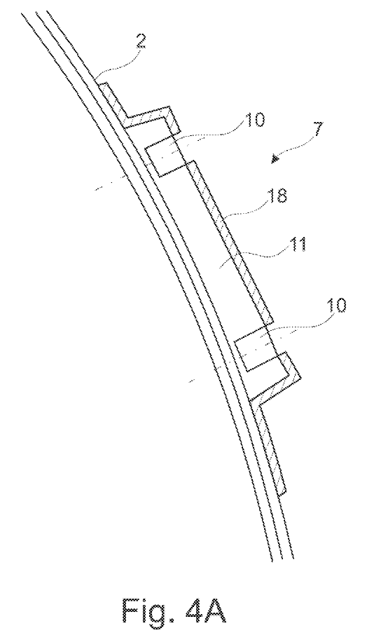

FIG. 4 shows a detail in a side view of an annular component;

FIG. 4A shows a sectional view of the detail along the line C-C of FIG. 4 in the axial direction;

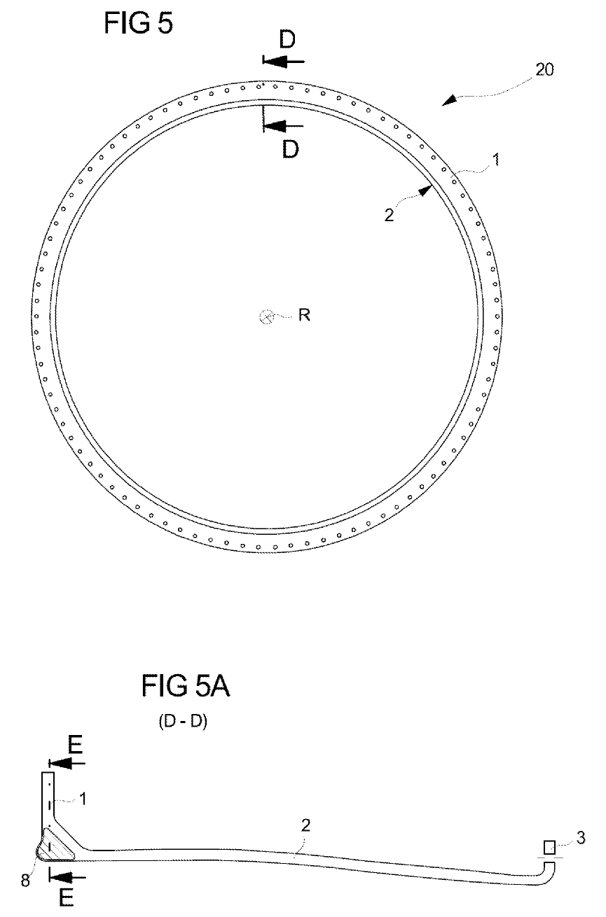

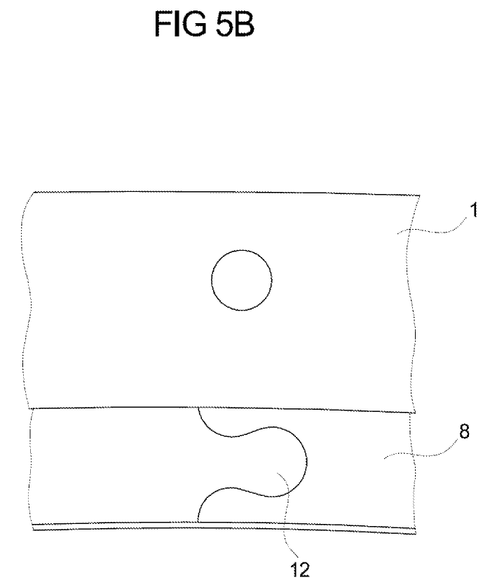

FIG. 5 shows a side view of a fourth embodiment of the annular component in the axial direction;

FIG. 5A shows a sectional view of the fourth embodiment along the line D-D in FIG. 5;

FIG. 5B shows a detailed view of parts of a foam core with a dovetail connection along the line E-E in FIG. 5A;

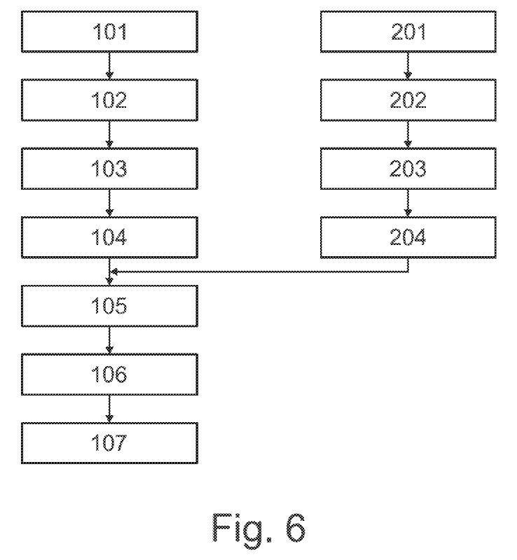

FIG. 6 shows a flow chart for an embodiment of a method for producing an annular component;

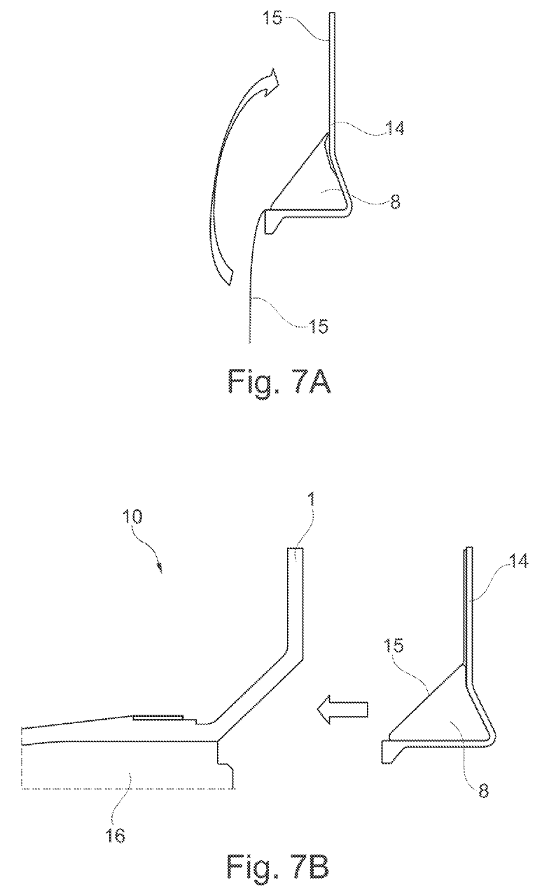

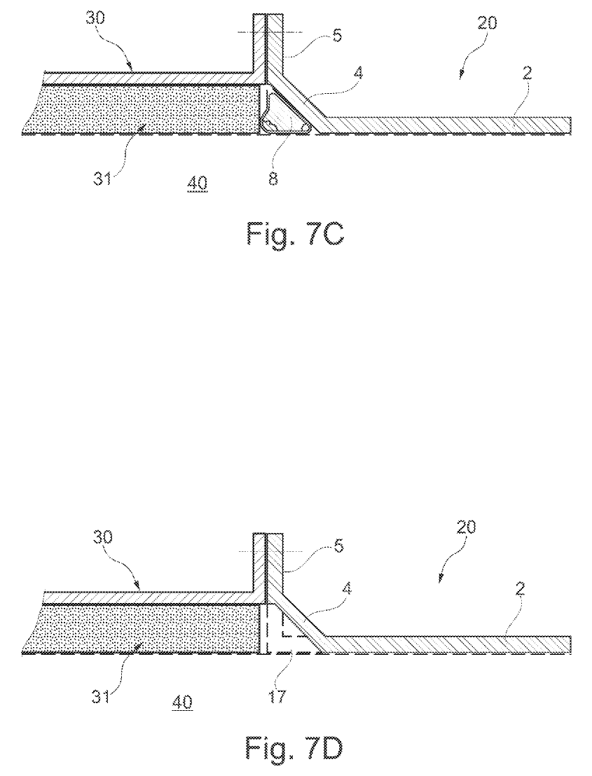

FIG. 7A shows a schematic illustration of an embodiment of a method step for producing a foam core;

FIG. 7B shows a schematic illustration of an embodiment of method step for joining the foam core and annular component;

FIG. 7C shows an illustration of a first embodiment of the annular component with a foam core in an assembly comprising a neighboring component;

FIG. 7D shows an illustration of a second embodiment of the annular component with a foam core in an assembly comprising a neighboring component.

FIGS. 1-1A show a first embodiment of an annular component 20 for an aircraft gas turbine. FIG. 1 here shows a view in the axial direction, i.e. in the direction of an axis of rotation R of the aircraft gas turbine (not illustrated here). If the annular component 20 is designed, for example, as a housing for a fan (not illustrated here), the axial direction would be the axis of rotation R of the fan. The direction of flight (see FIG. 1A) of the aircraft gas turbine would be coaxial to the axis of rotation R. In FIG. 1, a sectional plane A-A is indicated, with the corresponding sectional view being illustrated in FIG. 1A.

As can be seen in FIG. 1A, the annular component 20 has a front flange structure 1 and a rear flange structure 3 - as seen in the direction of flight F or in the direction of the axis of rotation R. An annulus structure 2, whereof the wall is arranged approximately parallel to the axis of rotation R, is arranged between the flange structures 1, 3. In the view shown, the annulus structure 2 has a slightly upwardly (i.e. radially outwardly) curved form, i.e. the annulus structure 2 does not need to have a flat or level base.

The embodiments which are described below have variable cross-sectional forms Q1, Q2 and/or variable material arrangements M1, M2 in the circumferential direction U and/or perpendicularly to the circumferential direction U in each case. It is, for example, possible to use only one material and to vary only the cross-sectional forms Q1, Q2.

FIG. 1A shows variable material arrangements M1, M2 in a plane perpendicular to the circumferential direction U. This means that different materials may be used in the axial direction in the annulus structure 2.

In this regard, the first material arrangement M1, which is nearer to the front flange structure 1 than the second material arrangement M2, might have a higher strength and a higher weight, for example, if the mechanical loads and/or the thermal loads on the front flange structure 1 are higher than in the rear flange structure 3. The second material arrangement M2, which is nearer to the rear flange structure 3, may be adapted to the load, e.g. it may be designed to be lighter.

The embodiment according to FIG. 1A therefore shows a variability in the axial direction (i.e. perpendicularly to the circumferential direction), a situation being shown here in which the material arrangements M1, M2 extend in the same manner around the circumference, i.e. the material arrangements M1, M2 form annular material arrangements M1, M2.

In other embodiments, the material arrangements M1, M2 extend over only a portion of the circumference in each case, i.e. different material arrangements M1, M2 are present in the circumferential direction U, as illustrated in FIG. 1B. By way of example, a segment in the top part of the annulus structure 2 has a material arrangement M2; the complementary segment in the bottom part of the annulus structure 2 has a material arrangement M1. A housing may thus be adapted to different mechanical and/or thermal loads on the top and bottom side (or on the lateral surfaces), for example. It is therefore not compulsory for the material arrangements M1, M2 to extend around the same parts of the circumference in each case. In the embodiment shown, it is assumed that the different material arrangements M1, M2 extend over the entire region of the annulus structure 2 in the axial direction R, although this is not compulsory.

The embodiments shown by way of example here have two different material arrangements M1, M2. However, it is possible to use more than two different material arrangements M1, M2 in order to meet particular load requirements. The embodiments of FIGS. 1A-1B may also be combined with one another in that the material arrangements M1, M2 are arranged differently both in the circumferential direction and perpendicularly thereto. The materials may therefore be used specifically where they are needed. In each case, an anisotropic material distribution is then present in the annulus structure 2.

In addition or alternatively to the variable material arrangements M1, M2, the cross-sectional forms Q1, Q2 of the annulus structure 2 may also be designed to be variable. That is to say that the cross-sectional forms Q1, Q2 may be designed to be variable in the circumferential direction U and/or perpendicularly to the circumferential direction U, as illustrated in FIGS. 1C-1D.

FIG. 1C shows an embodiment with variable cross-sectional forms Q1, Q2 in a plane perpendicular to the circumferential direction U. The first cross-sectional form Q1, which is nearer to the front flange structure 1, has a larger cross section (i.e. a larger wall thickness) than the second cross-sectional form Q2, which is located axially behind it. As in the case of the variable material arrangements M1, M2 in the embodiments of FIGS. 1A-1B, the cross section of the annulus structure 2 may be specifically adapted to mechanical loads and/or thermal loads.

The embodiment according to FIG. 1C therefore shows a variability in the cross sections Q1, Q2 in the axial direction (i.e. perpendicularly to the circumferential direction U), a situation being shown here in which the cross-sectional forms Q1, Q2 extend in the same manner around the circumference.

In other embodiments, the variable cross-sectional forms Q1, Q2 extend over only a portion of the circumference in each case, i.e. different cross-sectional forms Q1, Q2 are present in the circumferential direction U, as illustrated in FIG. 1D. By way of example, a segment in the left-hand side of the annulus structure 2 here has a greater wall thickness (cross-sectional form Q1) than the complementary segment of the annulus structure 2. A housing may thus also be adapted to different mechanical and/or thermal loads on the top and bottom side (or on the lateral surfaces), for example. It is therefore not compulsory for the different cross-sectional forms Q1, Q2 to extend around the same parts of the circumference in each case. In the embodiment shown, it is assumed that the different cross-sectional forms Q1, Q2 extend over the entire region of the annulus structure 2 in the direction of the axis of rotation R, although this is not compulsory.

The embodiments shown by way of example here have two different cross-sectional forms Q1, Q2. However, it is possible to use more than two different cross-sectional forms Q1, Q2 in order to meet particular load requirements. The embodiments of FIGS. 1C-1D may also be combined with one another in that the cross-sectional forms Q1, Q2 are arranged differently both in the circumferential direction and perpendicularly thereto. Different material thicknesses may therefore be used specifically where they are needed. In each case, an anisotropic form is present as a result of the different cross-sectional forms Q1, Q2.

The embodiments having a variable material arrangement M1, M2 (see FIGS. 1A-1B) and having a variable cross-sectional form Q1, Q2 (see FIGS. 1C-1D) may be combined with one another in that, for example, the materials in a thickened wall region of the annulus structure 2 differ from the materials in a thinner wall region of the annulus structure 2.

In addition to this load-appropriate flexibility in the configuration of the annulus structure 2, it is the case in all embodiments according to FIGS. 1, 1A, 1B, 1C, and 1D that at least one of the flange structures 1,3 has at least two annular portions 4, 5 in the circumferential direction which are each arranged at a different angle α, β relative to the annulus structure 2.

For the sake of simplicity, this configuration of the at least one flange structure 1, 3 in FIGS. 1B and 1D is shown only for the front flange structure 1. However, the rear flange structure 3 may be designed in a similar manner.

The embodiments - as can be most clearly seen in FIG. 1A and 1C—have a substantially U-shaped cross section in the cross section perpendicular to the circumferential direction U, the front flange structure 1 extending approximately twice as far outwards in the radial direction as the rear flange structure 3. This may be designed differently in alternative embodiments. As already mentioned above, the base of the annulus structure 2 has a slightly curved design here, this form being dependent on the flow-conducting task of the annulus structure.

The rear flange structure 3 in the embodiment shown protrudes substantially at an angle γ of 90° from the cross-sectional area of the annulus structure 2. The angle of 90° here is determined between the center line / center plane of the wall of the annulus structure 2 and the center line / center plane of the wall of the rear flange structure 3, which intersect one another at an angle of 90°, as illustrated schematically in FIG. 1B. The angle γ here is measured in the direction of the wall of the annulus structure 2. The rear flange structure 3 here is formed in one piece with the annulus structure 2.

On the other hand, the front flange structure 1 in the embodiment shown has a somewhat more complex form (see FIG. 1E, for example). A first portion 4 follows at an angle α = 45° toward the front in the axial direction - i.e. as seen in the direction of flight F. The angle α is also determined between the center line / center plane of the cross section of the annulus structure 2 and the center line / center plane of the cross section of the first portion 4 here; the center lines / center planes intersect one another at an angle of 45°.

A second portion 5, which extends at an angle β=90° relative to the annulus structure 2, adjoins the distal end of the first portion 4. The angle β is therefore different from the first angle α. The angle β is, in turn, measured at the intersection point of the center lines (or intersection axis of the center planes). The angles α, β here are likewise measured in the direction of the wall of the annulus structure 2. The front flange structure 1 here is also formed in one piece with the annulus structure 2, so that the entire annular component 20 is formed in one piece. In alternative embodiments, the annular component 20 may also be produced from two or more structural elements.

As a result, in the embodiments shown here, the front flange structure 1 is firstly bent upwards at a relatively shallow first angle α in a first portion 4, with α being between 10 and 60°, for example . The second portion 5 then bends more steeply outwards - β=90°. Ultimately, the second portion 5 is then perpendicular to the annulus structure 2.

The embodiments shown here may be produced, in particular, as composite materials containing carbon fibers using a deposition method (automated fiber placement, AFP) for pre-impregnated fiber composite material (predominately semi-rigid fibers here). The bundles, e.g. of carbon fibers, are impregnated with epoxy resin and are deposited at angles of 0°, +45°, -45°, and 90°. As a result of the so-called staggering, the fibers may be deposited to form cross-sections which are variable (staggered layup).

As a result of this production method, the above-mentioned variable cross-sectional forms Q1, Q2 and/or the variable material arrangements M1, M2 may be realized, as illustrated in the figures. As mentioned, it is possible to save on weight as a result of this variability, since parts of the annular component 20 which are particularly highly loaded can be specifically reinforced.

Above all, the multi-angle (here two-angle α, β) design of the first flange structure 1 enables this to be produced in one layer, it being particularly possible to use tapes with fibers at a 90° angle so that the fibers are perpendicular to the axis of rotation R.

In one embodiment (see FIG. 1A), the annulus structure 2 is connected to a reinforcing structure 6 (e.g. by applying additional layers of the composite material or a metal part) or they are formed in one piece when depositing the fibers. This is particularly useful if, for example, relatively large mechanical loads act in a certain region of the annulus structure 2.

In the embodiment according to FIG. 1A, an additional fire protection layer 13 is arranged on the annulus structure 2. The fire protection layer 13 may be arranged partly or completely on the outer skin of the annulus structure 2, depending on requirements, in order to protect the outside against fire.

If the reinforcing structure 6 is made from, or comprises, a composite material, the fire protection layer 13 may cover the reinforcing structure 6. This is not compulsory if the reinforcing structure 6 is made from metal or another refractory material; it is then sufficient for the fire protection layer 13 to be arranged around the metal part.

A second embodiment is illustrated in FIGS. 2-2A, with FIG. 2 showing a view in the direction of the axis of rotation R which is comparable to that of FIG. 1, which means that the description above is essentially applicable.

However, the front flange structure 1 shown in the sectional view of FIG. 2A has an additional feature, namely a foam core 8 in the interior of the front flange structure 1 or a foam core 8 which can be connected to the front flange structure 1. The production of this foam core 8 is illustrated in more detail in association with the production method in FIGS. 6, 7A, and 7B. The integration of the annular component 20 having a foam core 8 with neighboring components is illustrated in FIGS. 7C and 7D.

As can be seen in FIG. 2A, the first flange structure 1 has a first angle α of 45° between the annulus structure 2 and the first portion 4. The second angle β between the annulus structure 2 and the second portion 5 of the first flange structure 1 is 90°. Efficient connection to a neighboring component is thus possible.

FIG. 3 shows a detail which is applicable in connection with one of the embodiments described above. The perspective illustration shows, in the circumferential direction U of the annulus structure 2, a region which is provided with an additional material 9 (patches), e.g. of metal, so that, in this region, the cross section increases perpendicularly to the axis of rotation R relative to the remaining region of the annulus structure 2. The additional material 9 here extends over the entire region (i.e. in the axial direction) of the annulus structure 2. This corresponds approximately to the embodiment shown in FIG. 1D. In other embodiments, the additional material does not extend over the entire width.

This additional material 9 may be also be, for example, a fire protection material, in order to protect the underlying composite material of the annulus structure 2 against high temperatures. As mentioned, this additional material does not cover the entire circumference of the annulus structure 2, which means that space remains for further arrangements or connection means 7, as illustrated in FIGS. 4-4A.

FIG. 4 shows the side view of part of an annular component 20, in which further additional materials 9’, 9” are arranged in the region of the annulus structure 2. This results in a local increase in the cross section in these regions in each case. In addition, a further connection means 7 is provided, which is shown in section along the line C-C in FIG. 4A. A mounting means (not illustrated here) may act on the connection means 7 (also referred to as a stop element or boss), for example. In the illustration in FIG. 4A, the connection means 7 is covered with a CFRP layer 18 during production (e.g. by winding, lamination or draping, depending on the production method), with metal threaded bushes 10 then being inserted into the composite material 11.

FIGS. 5, 5A, and 5B show a further embodiment, the view in FIG. 5 being comparable with the view in FIGS. 1 or 2. The section line D-D extends through the front flange structure 1, which is provided with a foam core 8 (see FIG. 5A), analogously to the embodiment according to FIG. 2A. The external geometry of the first flange structure 1 with the two differently angled regions corresponds here to the embodiment in FIG. 2A. As in the first embodiment, the annular component 20 has a substantially U-shaped cross-sectional form.

The section plane D-D, which is shown in FIG. 5A, passes through the axially outer region of the front flange structure 1. The section line E-E in FIG. 5B shows that individual parts of the foam filling 8 located around the radially inner region of the front flange structure 1 are connected by a dovetail structure 12. Therefore, individual parts of the foam filling 8 may be used, these then also being held together by the dovetail structure 12.

FIG. 6 shows a flow chart for an embodiment of a method for producing an annular component 20.

In a first step 101, the base body of the annular component 20 is produced on a peg-like deposition tool using an AFP (automated fiber placement) method, which is known per se.

This base body is then transferred to a flange shaping arrangement (step 102). Under the application of heat to the deposited laminate, the base body is shaped in the flange region in order to produce the flange structures 1, 3 (step 103). The flange structures 1, 3 are bent radially outwards here. The shaped component is then cooled (step 104).

In a subsequent step 105, a laminated foam core 8, i.e. a foam filling, (see also FIGS. 2A, 7A, and 7B) is connected to the annular component 20.

The foam core 8 here is prepared separately as a subassembly. In a first step 201, deposition/draping of CFRP layers 15 takes place in a corresponding molding tool 14. The parts of the foam core 8 are assembled in step 202 and then inserted into the molding tool with the prepared CFRP layers (see step 201) in a subsequent step 203. This is illustrated in FIG. 7A.

Then, in step 204, the CFRP layers 15 are turned back and draped so that they surround the foam core 8, as illustrated by the double-headed arrow in FIG. 7A. The foam core 8 has a substantially triangular cross-sectional area, the form essentially being adaptable to the configuration of the front flange structure 1.

FIG. 7B shows the joining together—indicated by the arrow pointing to the left—of the foam core 8 and the annular component 20, the annular component 20 being arranged in a molding tool 16.

The base body of the annular component 20 and the foam core 8 are transferred into an autoclave and autoclaved under pressure and heat (step 106). With this, the annular component 20 made of composite material and the foam core wound into the composite material connect to one another so as to produce one component.

After the autoclaving is completed, the annular component 20 is removed from the deposition tool in step 107 and machined in the subsequent step 108. To this end, CNC machining may take place. Flange bores and contours may also be produced

During this production process, a fire protection layer 13 is also applied. This may take place after the insertion of the foam core 8 in step 105. However, it is also possible for the fire protection layer 13 to be applied after the consolidation of the annular component 20 in the autoclave process (step 106).

FIG. 7C shows, on the right-hand side, an annular component 20 with the connected foam core 8. The foam core 8 fills the space radially within the chamfer of the first annular portion 4. The foam core 8 extends axially approximately to the plane of the outside of the front flange structure 1.

Two neighboring components 30, 31 adjoin the annular component 20 with the foam core 8 on the left. The first neighboring component 30 is a structural component which is able to support mechanical loads, for example. It is connected to the front flange structure 1, for example, via a screw connection. A second neighboring component, namely a functional neighboring component 31, is arranged radially within the first neighboring component 30. This may be a honeycomb structure, for example, which serves to reduce the noise of a fan. The internal diameter of the annular component 20 (with the foam core) and the functional neighboring component 31 are substantially identical so that a continuous gas path 40 is produced in the interior. In this configuration, the foam core 8 fills the gaps which are produced by the chamfer of the first annular portion.

FIG. 7D shows an alternative configuration to the embodiment according to FIG. 7C, which means that it is essentially possible to refer to the description above. A foam core 8 is not used here in the transition region to the neighboring components 30, 31, but rather an annular insert 17 having an angled cross section here. The production process proceeds, in particular, analogously to that according to FIG. 6

Therefore, the foam core 8 and the annular insert 17 are examples of inserts to which the annular component 20 may be connected.

### List of reference signs

1 Front flange structure

2 Annulus structure

3 Rear flange structure

4 First annular portion

5 Second annular portion

6 Reinforcing structure

7 Connection means

8 Foam core

9 Region having additional material (patch)

9’ Region having additional material (patch)

9” Region having additional material (patch)

10 Threaded bush in connection means

11 Composite material of the connection means

12 Dovetail connection

13 Fire protection layer

14 Molding tool, foam core

15 CFRP layer for sheathing the foam core

16 Molding tool, annular component

17 Annular insert

18 CFRP layer for covering the connection means

20 Annular component

30 Neighboring component, structural

31 Neighboring component, functional

40 Continuous gas path

F Direction of flight

M1 First material arrangement

M2 Second material arrangement

Q1 First cross-sectional form

Q2 Second cross-sectional form

R Axis of rotation

U Circumferential direction

α Angle between a first annular portion of a flange structure and annulus structure

β Angle between a second annular portion of a flange structure and annulus structure

γ Angle between rear flange structure and annulus structure

1. An annular component for an aircraft gas turbine, having a front flange structure in the direction of flight, a rear flange structure in the axial direction and an annulus structure arranged between the flange structures in the axial direction, wherein the annulus structure has a variable cross-sectional form and/or a variable material arrangement in the circumferential direction and/or perpendicularly to the circumferential direction and at least one of the flange structures has at least two annular portions in the circumferential direction, which are each arranged at a different angle relative to the annulus structure.

2. The annular component as claimed in claim 1, wherein a first angle between the annulus structure and the first portion of the flange structure, in particular the front flange structure, is between 10 and 60° and/or a second angle between the annulus structure and the second portion of the flange structure, in particular the front flange structure, is 90°.

3. The annular component as claimed in claim 1, wherein an angle between the annulus structure and rear flange structure is 90°.

4. The annular component as claimed in claim 1, wherein at least one flange structure and/or the annulus structure is connected to a reinforcing structure and/or a fire protection layer or is formed in one piece therewith.

5. The annular component as claimed in claim 1, wherein at least a region of the cross-sectional form of the annulus structure has a cross-sectional widening in the circumferential direction around the center line.

6. The annular component as claimed in claim 1, wherein at least one connection means, reinforcing structure and/or reinforcing means is arranged in an integrated manner on the outside of the annulus structure and/or in the annulus structure.

7. The annular component as claimed in claim 1, wherein the inside of the annulus structure is at least partly aerodynamically contoured.

8. The annular component as claimed in claim 1, wherein the annulus structure and/or at least one of the flange structures are connected to an insert, in particular a foam core or an annular insert.

9. The annular component as claimed in claim 8, wherein parts of an insert, in particular the foam core and/or the annular insert, are connected by a dovetail connection.

10. The annular component as claimed in claim 1, wherein it can be at least partly produced using a deposition method or winding method, in particular with a staggered layup.

11. The annular component as claimed in claim 10, wherein the type of deposition and/or the type of winding and/or the respective material are different at least in two regions of the flange structures and/or the annulus structure.

12. An aircraft gas turbine having at least one annular component as claimed in claim 1, in particular as part of a housing for a turbo drive, as part of a bypass duct of an aircraft drive or as part of an intermediate housing structure.

13. A method for producing an annular component as claimed in claim 1, in which at least one of the flange structures and/or the annulus structure are produced with wound fibers.

14. The method as claimed in claim 13, wherein
a) a base form of an annular component is generated,
b) at least one layer of a composite material is arranged in a molding tool, an insert - in particular a foam core or an annular insert - being arranged on this at least one layer,
c) the insert being sheathed by the at least one layer, and then
d) the insert is connected to the base form of the annular component, in particular in an autoclave.
